(19) United States
(12) Patent Application Publication
(10) Pub. No.: US 2026/0286864 A1
(43) Pub. Date: Sep. 24, 2026

(54) DUCT ARRANGEMENT FOR AN AIR FLOW BETWEEN ANNULAR CASINGS OF AN AIRCRAFT PROPULSION ASSEMBLY

(71) Applicant: SAFRAN POWER UNITS, TOULOUSE (FR)

(72) Inventors: Alain Roger Antoine DELBEZ, MOISSY-CRAMAYEL (FR); Serge Marie Gabriel COT, MOISSY-CRAMAYEL (FR); Vincent Bruno Jean-Marie ROY, MOISSY-CRAMAYEL (FR)

(73) Assignee: SAFRAN POWER UNITS, TOULOUSE (FR)

(21) Appl. No.: 19/477,355

(22) PCT Filed: Apr. 16, 2024
(86) PCT No.: PCT/FR2024/050498

§ 371 Date: Oct. 21, 2025

(30) Foreign Application Priority Data
Apr. 24, 2023 (FR) FR2304086

(51) Int. Cl. F01D 25/28; F02K 3/06

(52) U.S. Cl. CPC F01D 25/28; F02K 3/06; F05D 2220/323; F05D 2260/38; F05D 2300/501

(57) ABSTRACT

A duct arrangement for an air flow for an aircraft propulsion assembly includes an inner annular casing which extends around a longitudinal axis, an outer annular casing which extends around the inner annular casing, the inner and outer annular casings defining therebetween a flow channel for an air flow. A connecting device connects the inner annular casing to the outer annular casing and is configured to transmit forces from one annular casing to the other. The connecting device includes elastically deformable members configured to allow relative movements between the inner and outer annular casings.

### TECHNICAL FIELD OF THE INVENTION

The technical field of the present invention is that of propulsion assemblies, for example for an aircraft, comprising a turbomachine and a nacelle surrounding the turbomachine.

The present invention relates in particular to a duct arrangement for an air flow for such an aircraft propulsion assembly. In particular, this arrangement allows to connect annular casings, respectively internal and external, of the aircraft propulsion assembly.

### TECHNICAL BACKGROUND

The prior art comprises in particular the documents US-A1-2013/309070, U.S. Pat. No. 5,181,675, US-A1-2009/134271 and US-A1-2013/051981.

It is known from the prior art, as illustrated in FIG. 1, that a propulsion assembly 1, in particular for an aircraft, comprising a turbomachine 2 and a nacelle 3 configured to be attached around the turbomachine 2. The propulsion assembly 1 extends along a longitudinal axis X.

Generally, the turbomachine 2 extends around a longitudinal axis corresponding to the axis X. The turbomachine generally comprises several modules comprising, from upstream to downstream in the direction of gas flow, a fan, one or more compressor stages (for example, a low-pressure compressor and a high-pressure compressor), a combustion chamber, one or more turbine stages (for example, a high-pressure turbine and a low-pressure turbine), and a gas exhaust nozzle. When the fan is at the front of the turbomachine 2, it delivers a compressed air flow which is separated into two concentric annular flows: a primary air flow F1 and a secondary air flow F2 extending around the primary air flow F1.

In FIG. 1, the turbomachine 2 comprises annular casings 20, 22, 24, known as internal casings (with respect to the axis X), which can extend around the fan and the rest of the modules of the turbomachine 2 (i.e. the compressor and turbine stages, the combustion chamber and/or the gas exhaust nozzle). Classically, the nacelle 3 also extends along a longitudinal axis which corresponds to the axis X. The nacelle 3 may comprise one or more annular casings 32, 34, referred to as external (with respect to the axis X), forming cowls for example. The nacelle is therefore a fairing element that protects the turbomachine. The external annular casing(s) 32, 34 are attached to at least one of the internal annular casings 22, 24.

In FIG. 1, the nacelle 3 comprises, from upstream to downstream in the direction of gas flow, an annular air inlet structure 30, a first external annular casing 32 surrounding the fan (and therefore the first internal annular casing 20 of the fan) and a second external annular casing 34 forming, for example, a thrust reverser in which the rest of the turbomachine modules are located. The nacelle 3 (in particular the first and second external annular casings 32, 34) is generally mounted on at least one suspension 4a, 4b (e.g. an aircraft pylon) of an aircraft structure (e.g. an aircraft wing or along an aircraft fuselage), particularly towards the rear of this aircraft. To this end, fasteners 5a, 5b forming connecting devices of the propulsion assembly 1 to the aircraft are located in two transverse planes: an upstream plane passing through a first internal annular casing 22 (referred to as the intermediate casing) and a downstream plane passing through a second internal annular casing 24 (referred to as the exhaust casing). The fasteners 5a, 5b are located in particular at the level of an annular flow channel V of the secondary air flow F2 of the propulsion assembly 1. This annular flow channel V is delimited by the internal 20, 22, 24 and external 32, 34 annular casings.

To ensure downstream attachment, in the case of mounting on the fuselage, the fastener 5b comprises a first structural ring 50 at the level of the annular flow channel V of the secondary air flow F2, this first ring 50 being attached to the second external annular casing 34. The first ring 50 is connected by arms or connecting rods 51 to a shell or second ring 52 attached to the second internal annular casing 24 of the exhaust. The patent application EP-A1-2022973 describes an example of the structure of this downstream attachment of the propulsion assembly to the aircraft.

The connection between the first and second rings 50, 52 may take the form of radial arms distributed around the axis X and rigidly attached to the first and second rings 50, 52. This connection may also take the form of connecting rods 51 inclined with respect to axis X, as shown in FIGS. 2a and 2b. The connecting rods 51 are attached to the first and second rings 50 and 52 by fasteners 53 of the clevis, ball joint, and axle type. Such a fastener 53 is formed by two clevises, single or double, one secured to the end of the connecting rod 51 and the other to a wall of the ring 50, 52 and traversed by a common axis. More particularly, the connecting rods 51 are arranged in pairs, the connecting rods 51 of each pair being tangential to the second ring 52 of the second internal annular exhaust casing 24 while converging on a fastener of the first ring 50 of the second external annular casing 34.

Whether the connection is formed by radial arms or connecting rods 51, it is hyperstatic; inertial forces generated by the turbomachine 2, for example, will pass through all the arms or connecting rods 51. In particular, these inertial forces are mainly generated by the mass of a rear part of the turbomachine (i.e. that of a high-pressure body generally comprising a high-pressure compressor and a high-pressure turbine of the turbomachine). In addition, this rear part of the turbomachine may be cantilevered from the second internal annular casing 24, meaning that it remains sensitive to inertial stresses, in particular inertial stresses in the radial planes passing through the fastener 5b. In the prior art solutions, all the elements of the connection pins, clevises, ball joints, connecting rods or arms-are dimensioned to mechanically withstand these inertial forces. This allows radial rigidity to the rear section of the turbomachine. Furthermore, insofar as the inertial forces potentially pass through all the arms or connecting rods 51, the first ring 50 should also be capable of withstanding these loads around its entire circumference. The first ring 50 is therefore sized accordingly. The mass of the connecting device (i.e. fastener 5b) is consequently high. Thus, the connecting device according to such a configuration may have the disadvantage of having a large radial and axial overall dimension due to the high number of connecting elements.

In addition, it may be necessary for the fastener 5b to also comply with the following requirements:
a given radial stiffness to limit the movement of the high-pressure body of the turbomachine and transfer the aforementioned inertial forces,
a tolerance to a relative axial expansion between the interior and exterior of the turbomachine in contact with, respectively, the primary flow at a higher temperature and the secondary air flow at a cooler temperature, and
avoid obstructing or disturbing the flow of secondary air flow in the annular flow channel so as not to affect the performance of the turbomachine.

In this context, it is interesting to propose a solution to allow overcoming the disadvantages of the prior art.

In particular, the purpose of the present invention is to propose a duct arrangement for an air flow between internal and external annular casings for an aircraft propulsion assembly which, while ensuring that the thrust forces generated by one of the annular casings are taken up, allows to reduce the radial and/or axial overall dimension of this arrangement.

The present invention also aims to allow this duct arrangement for the air flow in the aircraft propulsion assembly to limit the flow disruption of the air flow in a flow channel of the air flow defined between the internal and external annular casings.

### SUMMARY OF THE INVENTION

The present invention thus provides a duct arrangement for an air flow for an aircraft propulsion assembly, the arrangement comprising:
an internal annular casing extending around a longitudinal axis X,
an external annular casing which extends around the internal annular casing, the internal and external annular casings defining between them a flow channel for an air flow, and
a connecting device linking the internal annular casing to the external annular casing and configured to transmit forces from one annular casing to the other.

According to the invention, said connecting device comprises elastically deformable members configured to allow relative movements between the internal and external annular casings.

This solution therefore allows the above-mentioned objective(s) to be achieved. In general, the invention allows the simplification of the connection between the internal and external annular casings, thereby reducing its radial and/or axial overall dimension. To achieve this, the connecting device of the invention proposes to incorporate elastically deformable members to replace the numerous articulated, rigid, hyperstatic, and bulky pieces of the prior art. The particular dimensions of the elastically deformable members allow radial and/or axial movement between the internal and external annular casings, while fulfilling the primary functions of the connecting device (i.e. attaching the annular casings together and transmitting forces, for example of the inertial type, from one annular casing to the other). In this way, the overall weight of the arrangement is significantly reduced. In addition, the assembly of the connecting device of the invention between the annular casings is easier and simpler for an operator.

In addition, the connecting device of the invention installed at the level of a flow channel for an air flow (in particular a secondary air flow) in the propulsion assembly allows the flow of this air flow to remain undisturbed (or only very slightly disturbed). In this way, the overall performance of the aircraft propulsion assembly is optimized.

The invention therefore has the advantage of being based on a simple design, offering a very high reliability and low cost and overall dimension.

The term “elastically deformable member” refers to a piece or at least a portion of a part capable of reversible deformation (e.g. stretching, compression, bending, etc.) when forces are applied to it to transmit these forces between at least two elements. This piece or portion of a piece has in particular a certain degree of flexibility to allow relative movements between the two elements. This flexibility can be achieved through specific shapes and dimensions and/or an elastically deformable material. Thus, the pieces or portions of pieces that are articulated without elastic deformation (such as connecting rods, link rods, ball joints, etc.) cannot correspond to the elastically deformable members of the invention.

The duct arrangement according to the invention may comprise one or more of the following characteristics, taken singly or in combination with each other:
each of the elastically deformable members is selected from a spring, a bar and a pad;
the pads are made of an elastically deformable material, or the springs are embedded in an elastically deformable material, for example the elastically deformable material is of the elastomer or fluoroelastomer type;
said connecting device comprises two rings, respectively internal and external, connected to each other by so-called connecting bars, the internal ring being attached to the internal annular casing, the external ring being attached to the external annular casing and the connecting bars forming said elastically deformable members;
the internal and external rings and the connecting bars are made of a single piece;
each of the connecting bars is inclined tangentially with respect to the internal annular casing, for example each of the connecting bars extends at an angle of inclination with respect to the internal annular casing which is between 10° and 45°, this angle being measured in a plane P tangent to the axis X;
the connecting device comprises a slot at a connecting interface between each of the connecting bars and at least one of the internal and external rings;
each bar has a thickness less than a thickness of one of the internal and external rings, these thicknesses being measured along the axis X;
said connecting device consists of an annular row of springs, one of the two ends of the springs being attached to one of the annular casings and the other of the two ends of the springs bearing on the other of the annular casings;
said connecting device comprises two rings, respectively internal and external, connected to each other by springs, wherein the internal ring is attached to the internal annular casing, the external ring is attached to the external annular casing, and the springs form said elastically deformable members;
one of said annular casings or said internal and external rings comprise fastening members for attachment to the springs;
each of the springs is embedded in an elastically deformable material, for example an elastomer;
said connecting device comprises an annular row of pads, in which each of the pads comprises a first portion bearing on one of the annular casings and a second portion attached to the other of the annular casings, and the pads forming said elastically deformable members;
the connecting device comprising the elastically deformable members is made from a single piece;
the connecting device is formed by several pieces assembled together, at least one of the pieces of which comprises the elastically deformable members;
the elastically deformable members are evenly distributed around the axis X;
the internal and external rings comprise attachment orifices, these attachment orifices allowing the passage of screws, for example, to attach the internal and external rings to the annular casings, internal and external respectively;
the external ring is spaced from the internal ring by a distance of between 15 and 50 mm, this distance being measured in a plane perpendicular to the axis X ;
the internal ring has a first thickness of between 1 and 4 mm, the first thickness being measured along the axis X;
the external ring has a second thickness of between 1 and 4 mm, the second thickness being measured along the axis X;
each of the connecting bars has a third thickness of between 1 and 3 mm, the third thickness being measured along the axis X;
each of the fastening members for attachment to the springs is a lug or a needle;
the fastening member can be formed or attached to the internal and external rings or to one of the internal and external annular casings.

The invention also relates to a propulsion assembly for an aircraft comprising a turbomachine, and a nacelle surrounding at least part of the turbomachine. This propulsion assembly comprises an arrangement according to one of the characteristics of the invention, the internal annular casing of this arrangement being formed by a casing of the turbomachine and the external annular casing being formed by a nacelle or nozzle cowl.

### BRIEF DESCRIPTION OF THE FIGURES

The invention will be better understood and other details, characteristics and advantages of the present invention will become clearer from the following description made by way of non-limiting example and with reference to the attached drawings, in which:

FIG. 1 is a schematic perspective view of an aircraft propulsion assembly according to the prior art,

FIG. 2a is a schematic perspective view of a connecting device of the internal and external annular casings of the aircraft propulsion assembly shown in FIG. 1,

FIG. 2b is a schematic axial sectional view of the connecting device in FIG. 2a,

FIG. 3 is a schematic perspective view of an aircraft propulsion assembly according to the invention,

FIG. 4 is a schematic axial sectional view of a connecting device according to a first embodiment of the invention,

FIG. 5a is an enlarged partial view showing a schematic axial cross-section of the connecting device shown in FIG. 4,

FIG. 5b is an enlarged partial view showing a schematic perspective of the connecting device in FIG. 4 or FIG. 5a,

FIG. 6 is a schematic perspective view of an arrangement for the aircraft propulsion assembly of FIG. 3 comprising the connecting device of FIGS. 4, 5a and 5b,

FIG. 7a is a schematic axial sectional view of a connecting device according to a second embodiment of the invention,

FIG. 7b is an enlarged view showing a schematic perspective view of part of the connecting device shown in FIG. 7a,

FIG. 8a is a schematic axial sectional view of an arrangement for the aircraft propulsion assembly of FIG. 3 comprising a connecting device according to a third embodiment of the invention,

FIG. 8b is an enlarged view showing a schematic axial cross-section of a part of the connecting device shown in FIG. 8a,

FIG. 9a is a schematic axial sectional view of an arrangement for the aircraft propulsion assembly of FIG. 3 comprising a connecting device according to a fourth embodiment of the invention,

FIG. 9b is an enlarged view showing schematically in perspective and from above a part of the connecting device of FIG. 9a,

FIG. 9c is an enlarged view showing a schematic cross-section of part of the connecting device of FIG. 9a or FIG. 9b.

The elements with the same functions in the different implementations have the same references in the figures.

### DETAILED DESCRIPTION OF THE INVENTION

By convention in this application, the terms “inner” and “outer”, and “internal” and “external” are defined radially with respect to a longitudinal axis (such as that of an aircraft propulsion assembly). Thus, a cylinder extending along the longitudinal axis comprises an inner surface facing the axle of the engine and an outer surface opposite its inner surface. “Axial” or “axially” refers to any direction parallel to the longitudinal axis. Similarly, the terms “upstream” and “downstream” are defined in relation to the direction of air circulation in the aircraft propulsion system.

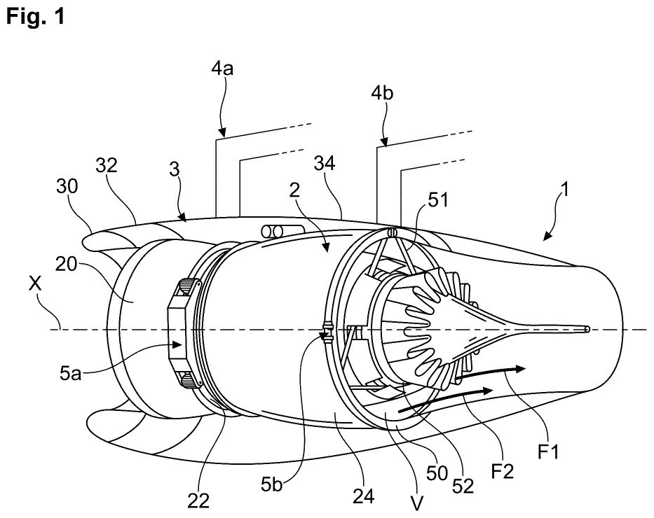

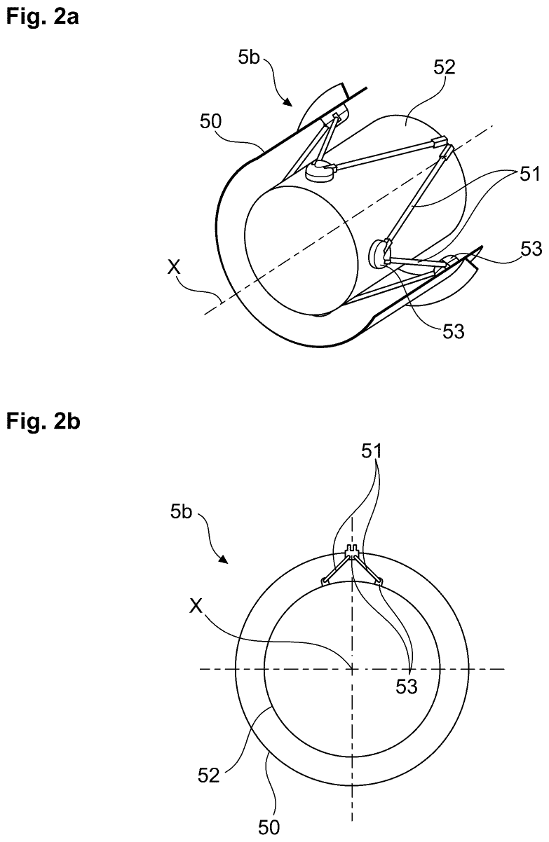

FIGS. 1, 2a and 2b have been described in the technical background to the present invention. These figures illustrate an aircraft propulsion assembly according to the prior art and a connecting device of the internal and external annular casings of this aircraft propulsion assembly.

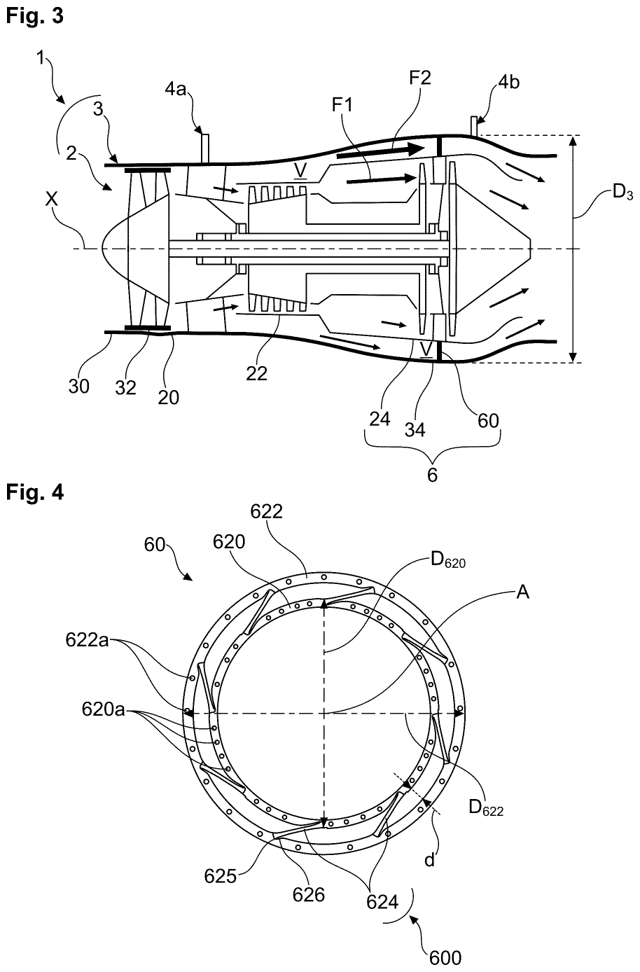

The invention applies in a general and non-limiting manner to a propulsion assembly 1, in particular for an aircraft, illustrated for example in FIG. 3.

This propulsion assembly 1 comprises a turbomachine 2 and a nacelle 3 surrounding at least part of the turbomachine 2. The propulsion assembly 1 extends along a longitudinal axis X in FIG. 3.

The turbomachine 2 can extend around a longitudinal axis which corresponds to the axis X. This turbomachine 2 can be configured to be attached to a structure of the aircraft (for example an aircraft wing or along an aircraft fuselage).

The turbomachine 2 generally comprises several modules comprising, from upstream to downstream in the direction of gas flow, a fan, one or more compressor stages (for example, a low-pressure compressor and a high-pressure compressor), a combustion chamber, one or more turbine stages (for example, a high-pressure turbine and a low-pressure turbine), and possibly a gas exhaust nozzle.

The turbomachine 2 may be a dual flow turbomachine. In this configuration, the fan, generally at the front of the turbomachine 2, delivers a flow of compressed air flow which is separated into two concentric annular flows: a primary air flow F1 and a secondary air flow F2 extending around the primary air flow F1.

The turbomachine 2 comprises several annular casings 20, 22, 24, referred to as internal (with respect to the axis X), such as at least one of the following casings:
an upstream internal annular casing 20 extending around the fan,
a first internal annular casing 22 (referred to as the intermediate casing) extending over an upstream part of the rest of the modules of the turbomachine 2 (i.e. the compressor stage in the example in FIG. 3), and
a second internal annular casing 24 (referred to as the exhaust casing) extending over a downstream part of the rest of the modules (i.e. the combustion chamber, the turbine stage and possibly the exhaust gas nozzle in the example shown in FIG. 3).

Regarding the nacelle 3, it can also extend along a longitudinal axis corresponding to the axis X. The nacelle 3 (and consequently the propulsion assembly 1) can have an external diameter D3 measured along a plane perpendicular to the axis X. This external diameter D3 can be less than 0.5 meters.

The nacelle 3 can be mounted on at least one suspension 4a, 4b (for example an aircraft pylon) of the aircraft structure, particularly towards the rear of the aircraft.

The nacelle 3 may comprise one or more annular casings 32, 34, referred to as external (in relation to the axis X). With reference to FIG. 3, the nacelle 3 comprises, from upstream to downstream in the direction of gas flow, an annular air inlet structure 30, a first external annular casing 32 surrounding the fan, and a second external annular casing 34 forming, for example, a thrust reverser in which the rest of the turbomachine modules are located (i.e. the compressor and turbine stages, the combustion chamber and possibly the gas exhaust nozzle in the example of FIG. 3). These external annular casings 32, 34 can form the annular cowls of the nacelle 3, for example.

The propulsion assembly 1 may comprise an ejection nozzle comprising an external annular structure forming an annular cowl that is distinct from one of the cowls of the nacelle 3. In this configuration (not shown in the figures), the nacelle surrounding the turbomachine is extended by this ejection nozzle. This ejection nozzle extends at least partly around the gas exhaust nozzle of the turbomachine.

In the example shown in FIG. 3, the first external annular casing 32 extends around the internal annular casing 20 upstream of the fan, the second external annular casing 34 extends around the first and second internal annular casings 22, 24.

The propulsion assembly 1 comprises a duct arrangement 6 for an air flow (in particular the secondary air flow F2). In particular, the arrangement 6 is located in a flow channel of the secondary air flow F2 of propulsion assembly 1. This flow channel can extend around the axis X and can be delimited by the internal 20, 22, 24 and external 32, 34 annular casings in the example shown in FIG. 3. The arrangement 6 allows, in particular, connecting one of the internal annular casings 20, 22, 24 to one of the external annular casings 32, 34.

The present application will now describe the arrangement 6 with reference to the connection between the second internal annular casing 24 of the turbomachine 2 and the second external annular casing 34 of the nacelle 3. This second external annular casing 34 may be one of the annular nacelle cowls 3 or the ejection nozzle of the propulsion assembly 1. Alternatively, the arrangement 6 may allow connection between the first internal annular casing 22 and the second external annular casing 34 (not shown in the figures).

Thus, the arrangement 6 comprises:
the second internal annular casing 24 which extends around the axis X,
the second external annular casing 34 which extends around the second internal annular casing 24, and
a connecting device 60 linking the second internal annular casing 24 to the second external annular casing 34 and configured to transmit forces from one annular casing to the other.

One of the distinctive aspects of the invention is that the connecting device 60 comprises elastically deformable members 600 configured to allow relative movements between the second internal and external annular casings 24, 34.

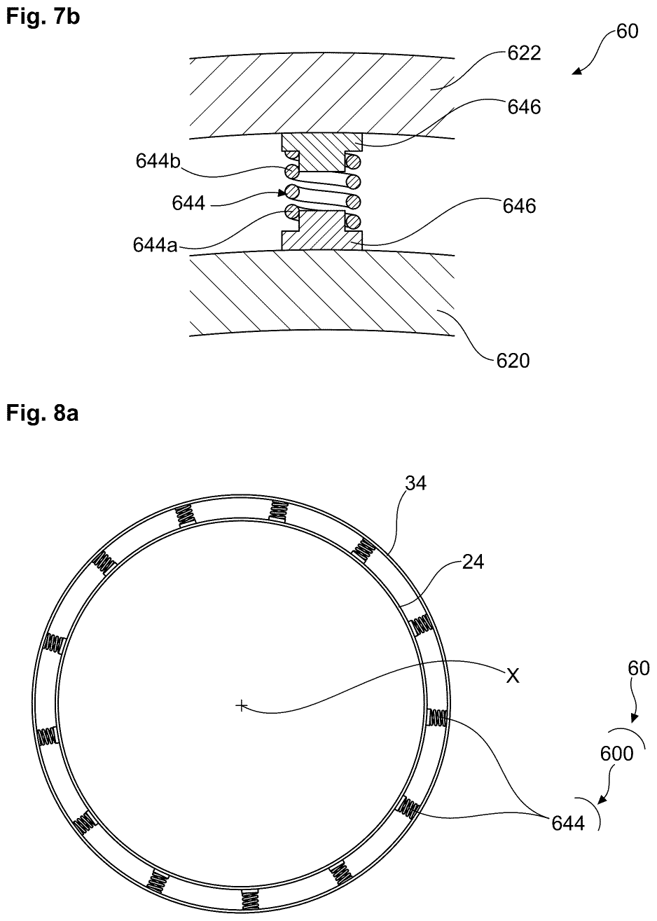

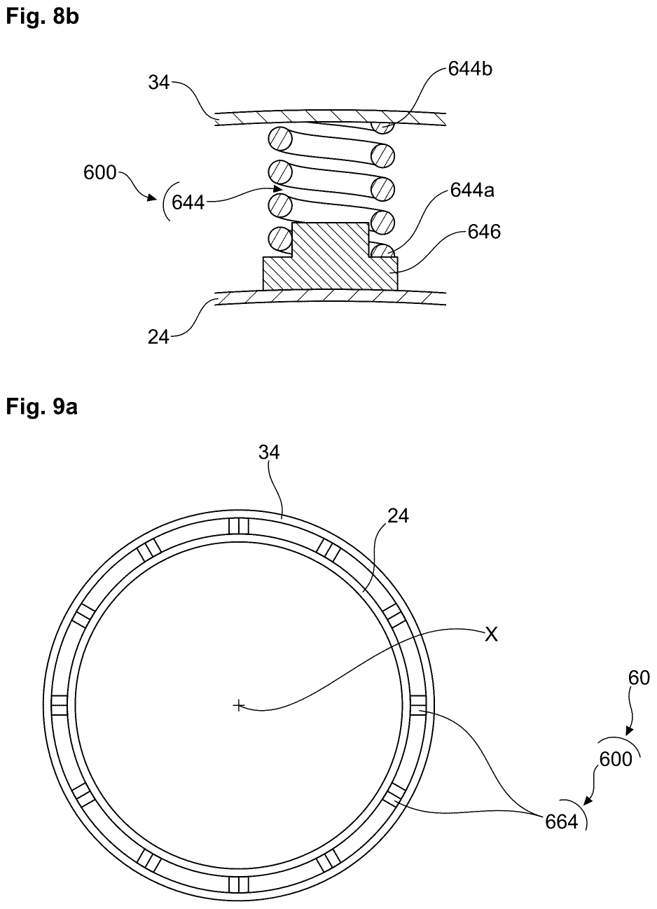

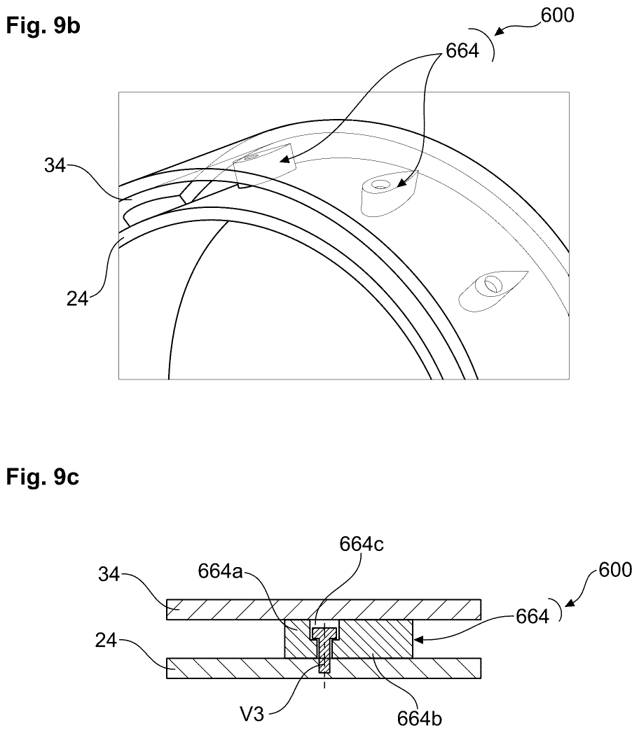

The connecting device 60 may be a single piece (i.e. made of material) comprising the elastically deformable members 600 (such as the device shown in FIGS. 4 to 6, and possibly FIGS. 8a, 8b and 9a to 9c). Alternatively, the connecting device 60 can be formed from several pieces assembled together, at least one of the pieces of which comprises the elastically deformable members 600 (such as the device shown in FIGS. 7a to 9c).

Each of the elastically deformable members 600 can be selected from a bar 624 (FIGS. 4 to 6), a spring 644 (FIGS. 7a, 7b, 8a and 8b) and a pad 664 (FIGS. 9a and 9c).

The bars 624 can each be made of a metallic material (e.g. steel).

The pads 664 can each be made of an elastically deformable material. By way of example, the elastically deformable material is of the elastomer or fluoroelastomer type. Preferably, the elastically deformable material is chosen to withstand a high temperature of up to 250° C., such as fluoroelastomer.

Advantageously, the springs 644 can be embedded (or otherwise enveloped or coated) in an elastically deformable material, for example an elastomer. The elastically deformable material provides a damping function for these springs, for example to reduce the intensity of vibrations transmitted to the connecting device 60 by the second internal annular casing 24.

The present application will now describe the various possible configurations of the elastically deformable members 600 making up the connecting device 60 of the invention with reference to FIGS. 4 to 9c.

FIGS. 4 to 6 illustrate a first embodiment of the connecting device 60 of the arrangement 6.

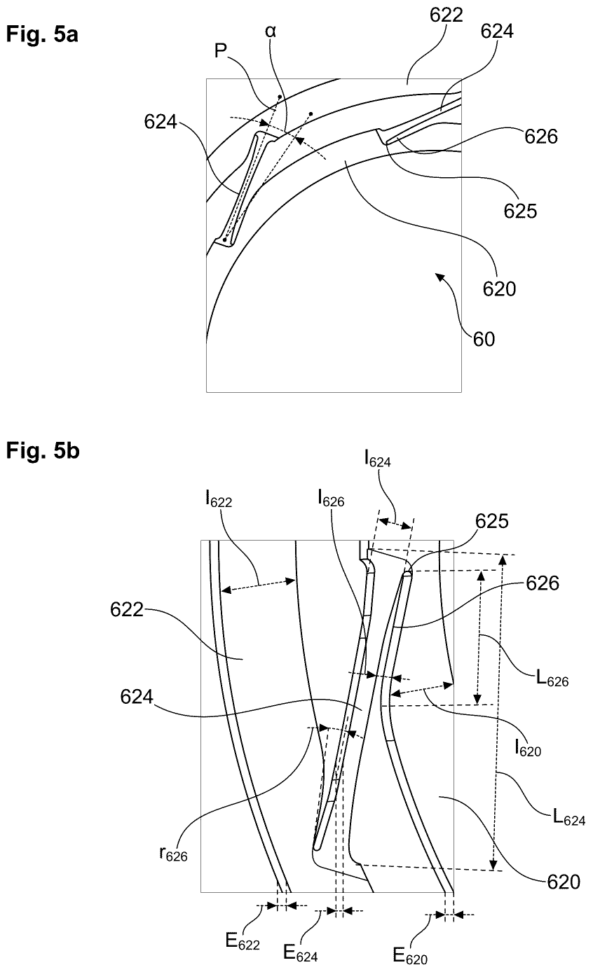

With reference to FIGS. 4, 5a and 5b, the connecting device 60 of the first embodiment may be a piece of revolution extending around a longitudinal axis A. This axis A corresponds substantially to the axis X when the arrangement 6 is installed in the aircraft propulsion assembly 1.

The connecting device 60 may comprise two rings, respectively internal 620 and external 622 connected to each other by bars 624, known as connecting bars. The connecting bars 624 are configured to allow relative movements between the internal and external rings 620, 622 (and therefore also between the second internal and external annular casings 24, 34) and thus form the elastically deformable members 600 of the first embodiment.

The internal ring 620 may comprise first orifices 620a. These first orifices 620a allow screws to pass through to attach this internal ring 620 to the second internal annular casing 24. In this way, the internal ring 620 can form a first flange for attaching the connecting device 60 to the second internal annular casing 24.

The internal ring 620 may have a first thickness E₆₂₀, this first thickness E₆₂₀ being measured along the axis A. This first thickness E₆₂₀ may be between 1 and 4 mm. For example, the first thickness E₆₂₀ is approximately 2 mm.

The internal ring 620 may have a first diameter D₆₂₀, this first diameter D₆₂₀ being measured along a plane perpendicular to the axis A. This first diameter D₆₂₀ may be between 250 mm and 350 mm.

The internal ring 620 may have a first width 1620 measured with respect to a plane transverse to the axis A. This first width 1620 may be between 15 and 25 mm.

The external ring 622 can extend coaxially around the internal ring 620. The external ring 622 can be spaced from the internal ring 620 by a distance d. This distance d can be between 15 and 50 mm. By way of example, the distance d could be around 17 mm. The distance d is measured in a plane perpendicular to the axis A.

The external ring 622 may comprise second orifices 622a. These second orifices 622a allow screws to pass through to attach this external ring 622 to the second external annular casing 34. In this way, the external ring 622 can form a second flange for attaching the connecting device 60 to the second external annular casing 34.

The external ring 622 may have a second thickness E₆₂₂, this second thickness E₆₂₂ being measured along the axis A. This second thickness E₆₂2 may be between 1 and 4 mm. By way of example, the second thickness E₆₂₂is approximately 2 mm. The first and second thicknesses E₆₂₀, E₆₂₂ may be identical or different.

The external ring 622 may have a second diameter D₆₂₂, this second diameter D₆₂₂ being measured along a plane perpendicular to the axis A. This second diameter D₆₂₂ may be between 320 mm and 500 mm. The first diameter D₆₂₀ may therefore be smaller than the first diameter D₆₂₂.

The external ring 622 may have a second width 1622 measured with respect to a plane transverse to the axis A. The first 1620 and second 1622 widths may be the same or different. This second width 1622 can be between 15 and 25 mm.

The connecting device 60 may comprise between three and twelve connecting bars 624. The number of connecting bars 624 can vary according to the dimensions (i.e. diameter, width and/or thickness) of the internal and external rings 620, 622 and/or the desired radial stiffness in operation. The example in FIG. 4 shows eight connecting bars 624 linking the internal and external rings 620, 622. These eight connecting bars 624 are evenly spaced around the axis A.

Each of the connecting bars 624 may have a third thickness E₆₂₄, this third thickness E₆₂₄ being measured along the axis A. This third thickness E₆₂₄may be less than the first and second thicknesses E₆₂₀, E₆₂₂. This limits stresses at the ends of the connecting bars, for example in the event of differential axial movement between the internal and external rings. Advantageously, the third thickness E₆₂₄ can be at least 1 mm. The third thickness E₆₂₄ can be between 1 and 3 mm. For example, the third thickness E₆₂₄ is approximately 1.6 mm.

Each of the connecting bars 624 may comprise a first length L₆₂₄, this first length L₆₂₄ being measured along the axis of the bar in the example of the FIG. 5b. This first length L₆₂₄ can be between 50 mm and 180 mm.

Each of the connecting bars 624 may have a third width 1624 measured with respect to a plane transverse to the axis A. The third width 1624 may be between 10 and 30% of the first 1620 and second 1622 widths. This third width 1624 can be between 2 and 8 mm.

Each of the connecting bars 624 can be inclined tangentially with respect to the internal ring 620. Each of the connecting bars 624 may extend at an angle of inclination a with respect to the internal ring 620 of between 10° and 45°, this angle α being measured in a plane P tangent to the axis A (or the axis X). For example, the angle α is between 10° and 20°, as shown in the example in FIG. 5a.

The connecting device 60 may comprise a connecting interface 625 between each of the connecting bars 624 and at least one of the internal and external rings 620, 622. A slot 626 may be located at this connecting interface 625. The slots 626 also reduce the stresses at the ends of the connecting bars 624, for example in the event of axial and/or radial movement between the internal and external rings 620, 622. These slots 626 also allow the first length L₆₂₄ of the connecting bars 624 to be increased, thereby reducing the radial stiffness of the connecting device 60.

Each slot 626 may have a second length L₆₂₆, this second length L₆₂₆ being measured along the axis of the slot in the example of FIG. 5b. This second length L₆₂₆ can be between 5 and 45% of the first length L₆₂₄. The second length L₆₂₆ can be between 15 and 50 mm. By way of example, the second length L₆₂6 may be approximately 25 mm.

Each slot 626 may have a fourth width I₆₂₆ measured with respect to a plane transverse to the axis A. The fourth width I₆₂₆ may be between 2 and 6 mm. For example, the fourth width I₆₂₆ can be between 2 and 4 mm.

The dimensions of the slots 626 may vary depending on the dimensions (such as the distance d or the first and second diameters D₆₂₀, D₆₂₂) of the internal and external rings 620, 622 and/or the angle α. By way of example, when the distance d between the internal and external rings 620, 622 is approximately 17 mm and the angle α is approximately 13°, the dimensions of the slots 626 may be approximately:
25 mm for the second length L₆₂₆,
1 mm for the radius r₆₂₆, and
between 2 and 4 mm for the fourth width I₆₂₆.

The internal and external rings 620, 622 and the connecting bars 624 can be formed in a single piece (i.e. made of material).

The connecting device 60 of the first embodiment (i.e. the bars 624) may be made of metal (e.g. steel).

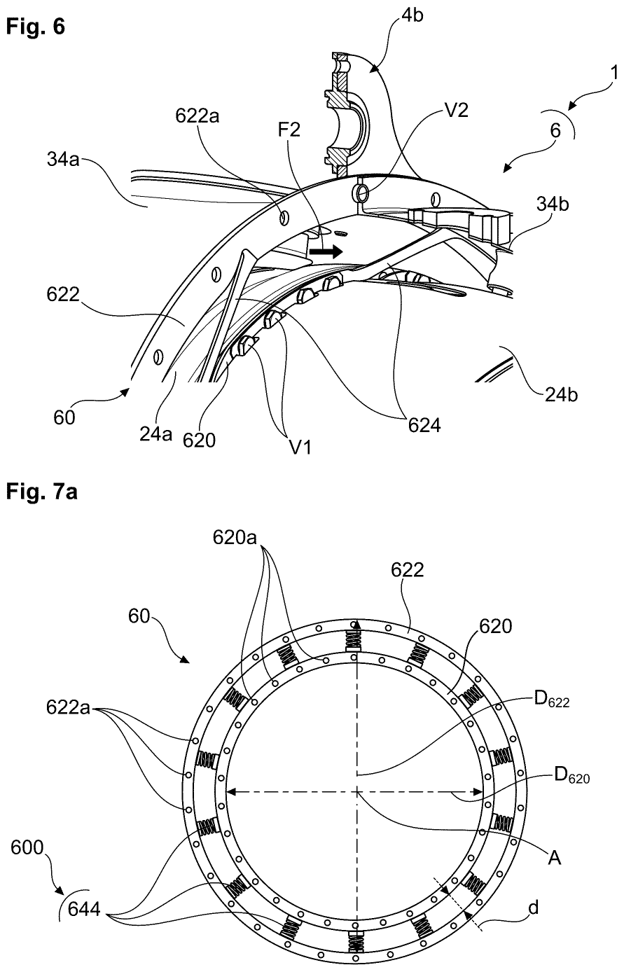

With reference to FIG. 6, this application will now describe the assembly of the connecting device 60 according to the first embodiment in the arrangement 6 of the aircraft propulsion assembly 1.

As mentioned above, the internal ring 620 is connected to the second internal annular casing 24 of the turbomachine 2, for example by first fixing screws V1, and the external ring 622 is attached to the second external annular casing 34 of the nacelle 3, for example by second fixing screws V2. In the example shown in FIG. 6, the internal ring 620 is inserted between two first annular walls, upstream 24a and downstream 24b respectively, of the second internal annular casing 24. The external ring 622 is inserted between two second annular walls, upstream 34a and downstream 34b respectively, of the second external annular casing 34.

In addition, the connecting device 60 (in particular the external ring 622) and the second external annular casing 34 can be connected to the suspension 4b of the aircraft.

In this way, the radial and/or axial overall dimension of the connecting device 60 of the invention are significantly reduced compared with the overall dimension of the fastener 5b of the prior art (FIGS. 2a and 2b). Furthermore, the connecting device 60 of the invention (in particular the connecting bars) does not disturb (or only slightly disturbs) the flow of the secondary air flow F2 during operation.

FIGS. 7a and 7b illustrate a second embodiment of the connecting device 60 of the arrangement 6.

The connecting device 60 of the second embodiment differs from the connecting device 60 of the first embodiment by the elastically deformable members 600. In fact, the connecting bars 624 of the first embodiment are replaced by springs 644.

With reference to FIGS. 7a and 7b, the connecting device 60 of the second embodiment may also be a part of revolution extending around a longitudinal axis A. This axis A corresponds substantially to the axis X when the arrangement 6 is installed in the aircraft propulsion assembly 1.

The connecting device 60 may comprise the two internal 620 and external 622 rings described in the first embodiment. These two internal 620 and external 622 rings are connected to each other by springs 644 in the connecting device 60 of the second embodiment. The springs 644 are configured to allow relative movements between the internal and external rings 620, 622 (and therefore also between the second internal and external annular casings 24, 34) and thus form the elastically deformable members 600 of the second embodiment.

The connecting device 60 may comprise between three and twenty springs 644. The number of springs 644 may vary according to the dimensions (i.e. the diameters D₆₂₀, D₆₂₂, the widths I₆₂₀, I₆₂₂ and/or the thicknesses E₆₂₀, E₆₂₂) of the internal and external rings 620, 622 and/or the desired radial stiffness in operation. The example in FIG. 7a shows fourteen springs 644 connecting the internal and external rings 620, 622. These springs 644 are evenly distributed around the axis A.

Each of the springs 644 may comprise a first end 644a and a second end 644b which is opposite the first end 644a. The first and second ends 644a, 644b are formed from a single piece (i.e., made of material).

Each of the springs 644 may be embedded in an elastically deformable material, for example an elastomer, to provide damping capacity for the connecting device 60.

The internal 620 and the external 622 rings may each comprise fastening members 646 for attachment to the springs 644. The fastening members 646 can be formed on or attached to the internal 620 and external 622 rings. The fastening members 646 and the internal 620 and external 622 rings can be one-part (i.e. made of material). By way of example, the fastening members 646 may each be a lug, a needle or any other element enabling the spring to be attached and retained on one of the internal and external rings 620, 622.

FIG. 7b shows lugs as an example of an fastening member 646 which can be formed or attached to the internal and external rings 620, 622. The first and second ends 644a, 644b of each spring 644 can be connected to the lugs of the internal and external rings 620, 622.

In a similar way to the arrangement 6 in FIG. 6, the internal and external rings 620, 622 are attached, respectively, to the second internal 24 and external 34 annular casings, for example by the first V1 and second V2 fastening screws.

The connecting device 60 of the second embodiment can be assembled between the second internal and external annular casings 24, 34 by keeping the springs 644 compressed and then releasing the springs 644.

In particular, the springs 644 can be formed or mounted compressed during the manufacture of the connecting device 60, and held pre-tensioned between the internal 620 and external 622 rings. When the internal 620 and external 622 rings are assembled on the second internal 24 and external 34 annular casings respectively, this connecting device 60 of the second embodiment can thus be made in one-part.

The radial and/or axial overall dimension of the connecting device 60 of the second embodiment are significantly reduced, and this connecting device 60 (in particular the springs 644) does not disturb (or only slightly disturbs) the flow of the secondary air flow F2 in the aircraft propulsion assembly 1 during operation.

FIGS. 8a and 8b illustrate a third embodiment of the connecting device 60 of the arrangement 6.

The connecting device 60 of the third embodiment differs from the connecting device 60 of the second embodiment in that the elastically deformable members 600 are mounted in the arrangement 6. In particular, the springs 644 of the third embodiment are arranged directly on the second internal 24 and external 34 annular casings (i.e. without the internal 620 and external 622 rings).

With reference to FIG. 8a, the connecting device 60 of the third embodiment may comprise one or more annular rows of springs 644. This annular row of springs 644 may comprise the springs 644 distributed evenly around the axis X.

The springs 644 of the connecting device 60 of the third embodiment may be similar to those described with reference to the connecting device 60 of the second embodiment.

Thus, the springs 644 are configured to allow the relative movements between the second internal and external annular casings 24, 34, thereby forming the elastically deformable members 600 of the third embodiment.

The connecting device 60 may comprise between three and twenty springs 644. The number of springs 644 may vary according to the dimensions (e.g. diameters) of the second internal and external annular casings 24, 34 and/or the desired radial stiffness in operation. The example shown in FIG. 8a illustrates thirteen springs 644 connecting the second internal and external annular casings 24, 34. These springs 644 are evenly distributed around the axis X.

Each of the springs 644 may be embedded in an elastically deformable material, for example an elastomer, to provide damping capacity for the connecting device 60.

In particular, one of the first and second ends 644a, 644b of each spring 644 may be attached (or connected) to one of the second internal and external annular casings 24, 34, and the other of the first and second ends 644a, 644b of each spring 644 may abut (or contact) the other of the second internal and external annular casings 24, 34. Each of the first ends 644a may be secured to one of the second internal and external annular casings 24, 34, and each of the second ends 644b may abut (or contact) the other of the second internal and external annular casings 24, 34. Preferably, each second end 644b may be able to slide on the corresponding second annular casing.

One of the second internal 24 and external 34 annular casings may comprise the fastening members 646 for attachment to the springs 644, as described above with reference to FIGS. 7a and 7b. These fastening members 646 can be welded or attached (for example by screws) to one of the second internal and external annular casings 24, 34. By way of example, the fastening members 646 may each be a lug, a needle or any other element enabling the spring to be attached and retained on one of the second internal and external annular casings 24, 34.

FIG. 8b illustrates, in a non-limiting manner, a lug as an example of an fastening member 646 which may be formed on or attached to the second internal annular casing 24. The first end 644a of the springs 644 is attached to the second internal annular casing 24 via the lug forming the fastening member 646, and the second end 644b of the springs 644 is in abutment with the second external annular casing 34.

In the arrangement 6 comprising the connecting device 60 according to the third embodiment, the springs 644 (or the annular row of springs 644) are mounted between the second internal 24 and external 34 annular casings by compression, and then the springs 644 are released.

The radial and/or axial dimensions of the connecting device 60 of the third embodiment are significantly reduced, and this connecting device 60 (in particular the springs 644) does not disturb (or only slightly disturbs) the flow of the secondary air flow F2 in the aircraft propulsion assembly 1 during operation.

FIGS. 9a, 9b and 9c illustrate a fourth embodiment of the connecting device 60 of the arrangement 6.

The connecting device 60 of the fourth embodiment differs from the connecting device 60 of the first to third embodiments in the elastically deformable members 600. In fact, the connecting bars 624 of the first embodiment and the springs 644 (or annular row of springs 644) of the second and third embodiments are replaced by pads 664 as elastically deformable members 600.

Referring to FIGS. 9a to 9c, the connecting device 60 of the fourth embodiment comprises one or more annular rows of pads 664. This annular row of pads 664 may comprise pads 664 distributed evenly around the axis X. The pads 664 may be arranged directly between the second internal and external annular casings 24, 34.

The pads 644 are configured to allow relative movements between the second internal and external annular casings 24, 34 and thus form the elastically deformable members 600 of the fourth embodiment. In addition, the pads 664 also provide a damping function, for example to reduce the intensity of vibrations transmitted to the connecting device 60 by the second internal annular casing 24.

Each of the pads 664 may comprise a first portion 664a connected to a second portion 664b opposite this first portion 664a. The first and second portions 664a, 664b are preferably formed in one piece (i.e. made of material).

The first portion 664a of the pads may rest on one of the second internal and external annular casings 24, 34, and the second portion 664b of the runners may be attached (or connected) to the other of the second internal and external annular casings 24, 34, for example by third fastening screws V3. Preferably, each first portion 664a of the pads may be able to slide on the corresponding second annular casing.

With reference to FIG. 9c, each of the pads 664 may comprise an opening 664c for the housing at least part of the third fastening screw V3. The opening 664c may be generally T-shaped in axial section. In a non-limiting manner, a head of the third fastening screws V3 can be completely embedded in this opening 664c (so that the head of the third screws V3 does not extend beyond the first portion 664a and is not in contact with one of the second annular casings), part of a threaded portion of the third fastening screws V3 can be housed in this opening 664c and another part of this threaded portion can be attached in the second internal annular casing 24.

With reference to FIG. 9b, each of the pads 664 can have a general shape with an aerodynamic profile (also referred to as a NACA profile). In particular, this improves the flow of secondary air flow F2 passing through the pads 664 when the connecting device 60 is in operation in the aircraft propulsion assembly 1.

The connecting device 60 may comprise between three and twenty pads 664. The number of pads 664 may vary according to the dimensions (e.g. diameters) of the second internal and external annular casings 24, 34 and/or the radial stiffness required during operation. The example shown in FIG. 9a illustrates twelve pads connecting the second internal and external annular casings 24, 34. These pads 664 are evenly distributed around the axis X.

The pads 664 can be made of an elastically deformable material (e.g. elastomer or fluoroelastomer).

In the arrangement 6 comprising the connecting device 60 according to the fourth embodiment, the pads 664 (or the annular row of pads 664) can be mounted between the second internal 24 and external 34 annular casings by compression, and then the pads 664 can be released.

The radial and/or axial overall dimension of the connecting device 60 of the fourth embodiment are also significantly reduced, and this connecting device 60 (in particular the pads 664) does not interfere (or only very slightly) with the flow of the secondary air flow F2 in the aircraft propulsion assembly 1 during operation.

The duct arrangement of the invention generally enables two coaxial elements to be connected together and defining between them a flow channel for an air flow, wherein one of the two elements may be an internal annular casing and the other of the two elements may be an external annular casing. The internal annular casing may be at least one of the annular casings of a turbomachine and the external annular casing may be at least one of the annular casings of a nacelle (forming, for example, an annular cowl of the nacelle) or of an exhaust nozzle (forming, for example, an annular cowl or another annular component of the exhaust nozzle) of the propulsion assembly, in particular of an aircraft.

1. A duct arrangement for an air flow for an aircraft propulsion assembly, the arrangement comprising:
an internal annular casing extending around a longitudinal axis,
an external annular casing which extends around the internal annular casing, the internal and external annular casings defining between them a flow channel for an air flow, and
a connecting device linking the internal annular casing to the external annular casing and configured to transmit forces from one annular casing to the other, said connecting device comprising elastically deformable members configured to allow relative movements between the internal and external annular casings, and in that each of the elastically deformable members is selected from a spring, a bar and a pad.

2. The arrangement according to claim 1, wherein the connecting device further comprises the elastically deformable members is made in a single piece.

3. The arrangement according to claim 1, wherein the connecting device is formed by several pieces assembled together, at least one of the pieces of which comprises the elastically deformable members.

4. The arrangement according to claim 1, wherein the pads are made of an elastically deformable material, or the springs are embedded in an elastically deformable material.

5. The arrangement according to claim 1, wherein said connecting device comprises two rings, respectively internal and external, connected to each other by connecting bars, the internal ring being attached to the internal annular casing, the external ring being attached to the external annular casing and the connecting bars forming said elastically deformable members.

6. The arrangement according to claim 5 wherein the connecting device further comprises the elastically deformable members is made in a single piece, and the internal and external rings and the connecting bars are formed in one piece.

7. The arrangement according to claim 5, wherein each of the connecting bars is inclined tangentially with respect to the internal annular casing.

8. The arrangement according to claim 5, wherein the connecting device comprises a slot at a connecting interface between each of the connecting bars and at least one of the internal and external rings.

9. The arrangement according to claim 5, wherein each bar has a thickness less than a thickness of one of the internal and external rings, these thicknesses being measured along the axis.

10. The arrangement according to claim 1, wherein said connecting device includes an annular row of springs, one of the two ends of the springs being attached to one of the annular casings and the other of the two ends of the springs bearing on the other of the annular casings.

11. The arrangement according to claim 1, wherein said connecting device comprises two rings, respectively internal and external, connected to each other by springs, wherein the internal ring is attached to the internal annular casing, the external ring is attached to the external annular casing, and the springs form said elastically deformable members.

12. The arrangement according to claim 10, wherein one of said annular casings or said internal and external rings comprise fastening members for attachment to the springs.

13. The arrangement according to claim 12, wherein each of the fastening members for attachment to the springs is a lug or a needle.

14. The arrangement according to claim 1, wherein said connecting device comprises an annular row of pads, wherein each of the pads comprises a first portion bearing on one of the annular casings and a second portion attached to the other of the annular casings and the pads forming said elastically deformable members.

15. A propulsion assembly for an aircraft comprising a turbomachine and a nacelle surrounding at least part of the turbomachine, and the duct arrangement according to claim 1, the internal annular casing of this arrangement being formed by a casing of the turbomachine, and the external annular casing of this arrangement being formed by a cowl of the nacelle or of an ejection nozzle.

16. The arrangement according to claim 4, wherein the deformable material is of the elastomer or fluoroelastomer type.

17. The arrangement according to claim 6, wherein each of the connecting bars extends at an angle of inclination (α) with respect to the internal annular casing, which is between 10° and 45°, the angle being measured in a plane tangent to the axis.
